(19) United States
(12) Patent Application Publication
(10) Pub. No.: US 2006/0050815 A1
(43) Pub. Date: Mar. 9, 2006

(54) Apparatus, module and computer program for minimizing correlation between signals

(75) Inventors: Bertrand Jacques Leonard Vandewiele, Eindhoven (NL); Paul Mattheijssen, Eindhoven (NL); Nanel Collados Asensio, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., EINDHOVEN (NL)

(21) Appl. No.: 10/536,214

(22) PCT Filed: Oct. 29, 2003
(86) PCT No.: PCT/IB03/04876

§ 371 Date: May 23, 2005

(30) Foreign Application Priority Data
Nov. 26, 2002 (EP) 02079909.4

(51) Int. Cl. H04L 27/06

(52) U.S. Cl. 375/343

(57) ABSTRACT

An apparatus that comprises means to simultaneously receive a first number of signals and a larger number of signal pathways comprises means to determine the correlation between first said number of signals for each of the possible signal pathways. The apparatus also comprises means to select from said second number of possible signal pathways an optimal subset of signal pathways that assure that there is a minimum level of correlation between said received first number of signals.

This invention relates to an apparatus that is arranged to simultaneously receive a first number of signals that can use a second number of signal pathways.

Multiple Input Multiple Output (MIMO) systems are arranged to simultaneously transmit and/or receive multiple signals. The technology is well known for its ability to improve the capacity of a wireless link. A MIMO system comprises multiple antennas for the transmission and reception of the data signals. MIMO systems may comprise antenna diversity techniques that use the Channel State Information (CSI) as a parameter for antenna selection.

However, using the CSI has the disadvantage that the received signals have to be processed first before the CSI can be obtained. This can be a time consuming process that may slow down or even hamper the response of the diversity scheme if the received signals are subjected to (fast) changing environmental conditions.

It is therefore an object of the present invention to provide an apparatus with an antenna diversity scheme that can respond adequately to fast changing environmental conditions. This is according to the present invention thereby realized by an apparatus comprising:
means for simultaneously receiving a first number of signals,
a second number of possible signal pathways, said second number being larger than said first number,
means for determining a correlation between said first number of signals for each of said possible signal pathways,
means for selecting from said second number of possible signal pathways an optimal subset of signal pathways having a minimal correlation between said received first number of signals.

The apparatus such as, a mobile device, a (portable) computer or even a base station, uses the correlation of the received signals as a criterion for selecting the optimum signal pathways that offer optimum transmission characteristics, such as signal throughput. This is achieved by first calculating the received signals for all possible pathways and next select the pathways having the lowest amount of correlation between the received signals.

Calculation of the correlation between the received signals can be done directly in the RF domain using the received signals directly as input i.e. without the need for demodulation. This assures a fast solution. Actually, correlation is a versatile criterion, which can be calculated in the base band and digital domain as well which makes it also a flexible solution. A further advantage of using the correlation as a parameter is that for the calculation of the correlation no special symbols are required which is the case when using the CSI.

According to an embodiment of the present invention, a suitable correlation based parameter can be the determinant of a correlation matrix. The correlation matrix comprising coefficients that relate to the correlation and cross correlation of the received signals. The determinant of this matrix provides a parameter that is a representation of the level of correlation between the received signals. A low value of the determinant represents a high level of correlation whereas a high value represents a low correlation level. Obviously, the less correlation the better is the overall performance.

According to another embodiment of the present invention the correlation-based parameter can be compared to a threshold value in order to verify if the correlation of the signals is still within acceptable limits. The performance of an apparatus according to the present invention heavily depends on the environmental conditions such as the availability a rich scattering environment. Under poor circumstances however, the performance of an apparatus according to the present invention, may drop below the performance of an apparatus using a single antenna. The threshold value basically represents a maximum allowable level of deterioration of signal throughput. Therefore, by comparing the correlation with this threshold value, the apparatus can determine if a reliable data transfer is still possible.

These and other aspects of the invention will be apparent from and elucidated with reference to the embodiments(s) described hereinafter.

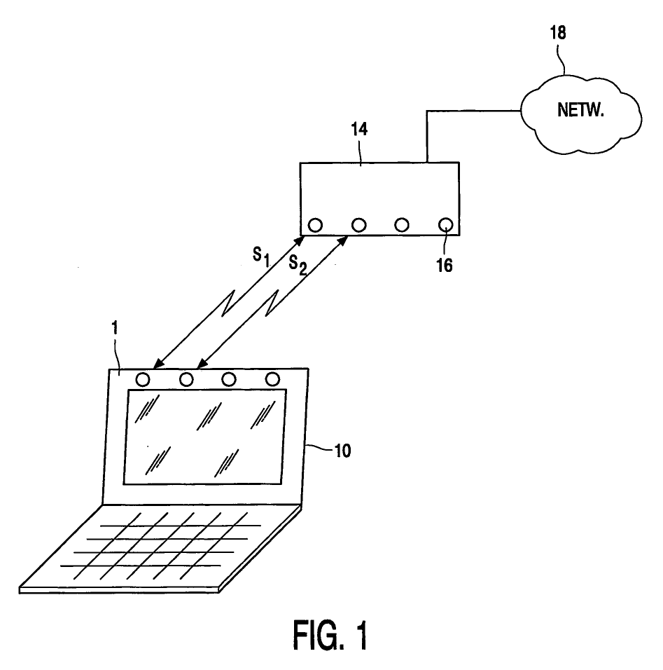

FIG. 1 shows an example of an apparatus according to the present invention.

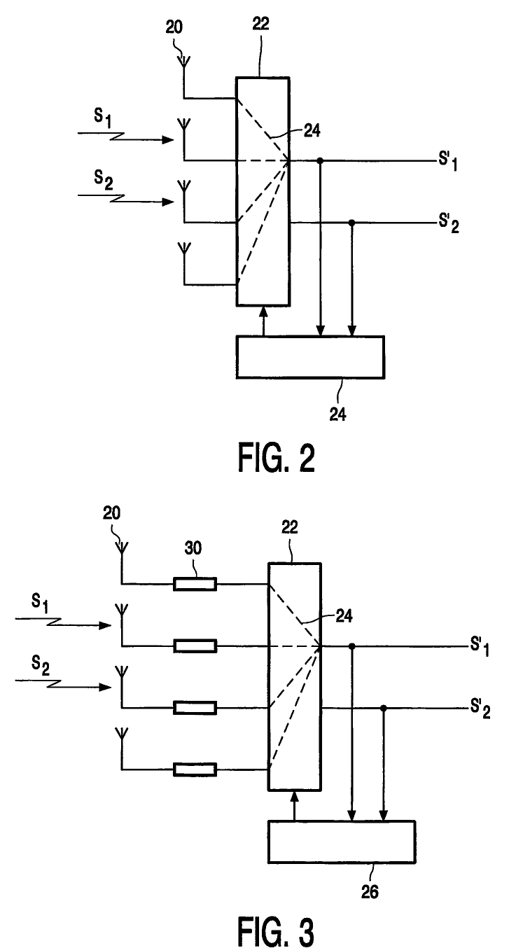

FIG. 2 shows a first embodiment of the present invention.

FIG. 3 shows a second embodiment of the present invention.

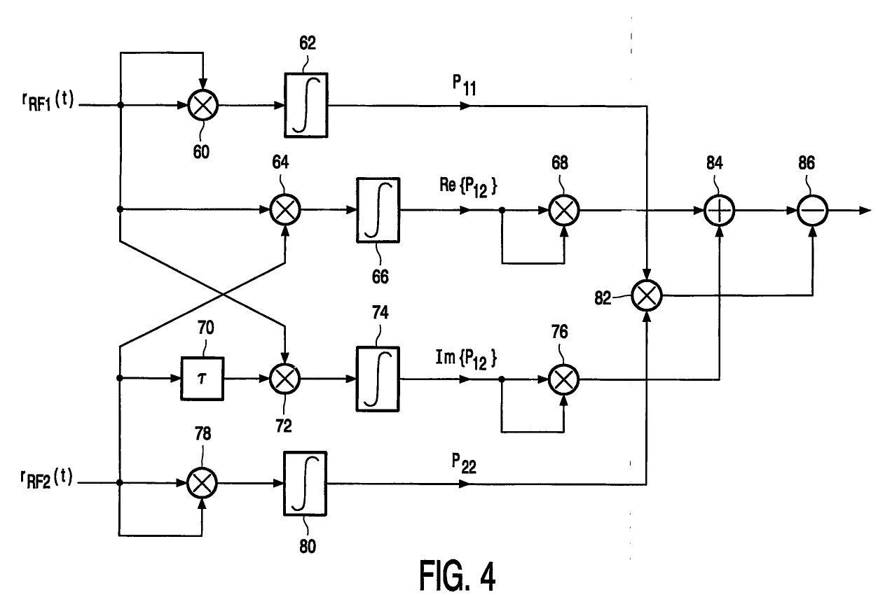

FIG. 4 shows an embodiment for calculating the determinant of the correlation matrix.

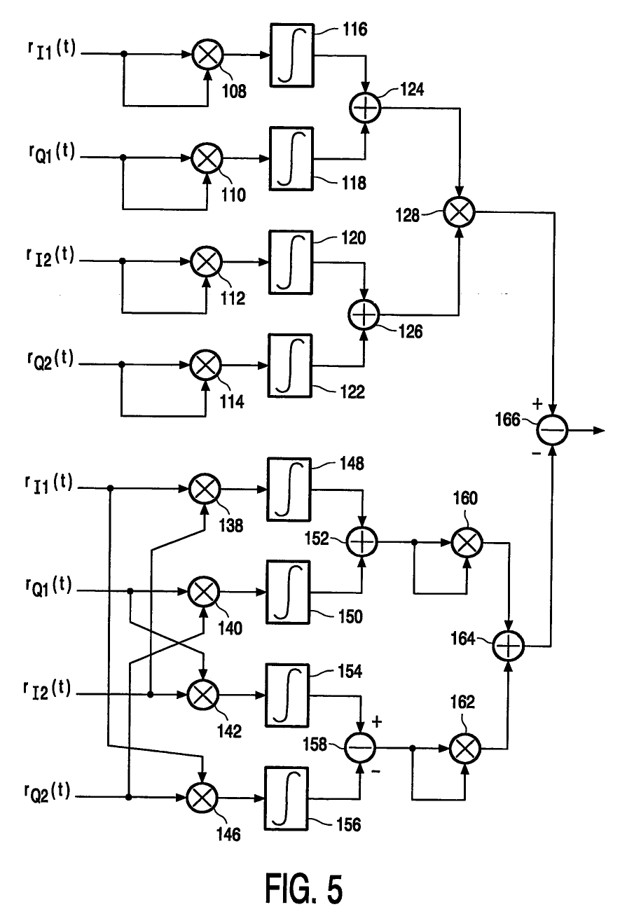

FIG. 5 shows another embodiment for calculating the determinant of the correlation matrix.

FIG. 1 shows an example of an apparatus 10 e.g. a laptop according to the present invention. The laptop 10 is connected to a network e.g. a LAN or WAN. To this end the laptop is equipped with a number of antennas 12. These antennas 12 exchange signals S1 and S2 with a base station 14 that also is equipped with antennas 16. It should be noted that the laptop comprises a larger number of antennas 12 than there are signals S1 S2. The apparatus 10 is arranged to select an optimum set of two antennas from the antennas 12 that guarantee optimal throughput of signals S1 and S2. Likewise, base station 14 can also be equipped with a similar algorithm to select an optimal set of antennas. In this example the number of antennas and the number of signals are just of illustrative purposes as it will be obvious to the man skilled in the art of telecommunications that other configurations are equally possible.

FIG. 2 shows a first embodiment according to the present invention. In FIG. 2, signals S1 and S2 are receivable by four antennas 20. The routed signals S1 and S2 are represented as S1′ and S2′. Signal S can follow various pathways 24. Likewise there are numerous pathways that can be followed by S2 (not shown here). Using pathway selection means 22 it is possible to select each of the possible pathways 24. The functionality of correlation means 26 is twofold. In the first place correlation means 26 calculates the correlation between signals S1′ and S2′ for each one of the possible pathways taken by S1 and S2. Secondly correlation means 26 is arranged to determine the optimal pathways i.e. those pathways that minimize the correlation between S1′ and S2′, and to communicate optimal pathways to the pathway selection means 22 for the actual selection of the pathways.

FIG. 3 shows a second embodiment according to the present invention. In FIG. 3, processing means 30 have been inserted between the antennas 20 and the pathway selection means 22. Processing means may comprise e.g. low noise amplifiers, demodulators, filters, automatic gain control elements and analogue to digital converters which can be used in the RF, IF, BB or digital domain.

The correlation matrix for determining the correlation between n different signals can be expressed as:

$$( \begin{matrix}{σ}_{11} & {σ}_{12} & … & {σ}_{1 n} \\ {σ}_{12}^{*} & {σ}_{22} & … & {σ}_{2 n} \\ ⋮ & ⋮ & ⋰ & ⋮ \\ {σ}_{1 n}^{*} & {σ}_{2 n}^{*} & … & {σ}_{nn}\end{matrix} )$$

Where σᵢᵢ is the autocorrelation factor and σᵢⱼ is the cross correlation factor.
In the RF domain σᵢᵢ can be calculated as:

$${σ}_{ii} = \frac{1}{T} {\int }_{T} {r}_{RFi}^{2} ( t ) ⅆ t$$

Whereas σᵢⱼ is split up into a real and an imaginary part:

$$Re \{ {σ}_{ij} \} = \frac{1}{T} {\int }_{T} {r}_{RFi} ( t ) {r}_{RFj} ( t ) ⅆ t$$

$$Im \{ {σ}_{ij} \} = \frac{1}{T} {\int }_{T} {r}_{RFi} ( t ) {r}_{RFj} ( t - τ ) ⅆ t , where τ = \frac{{T}_{c}}{4} and {T}_{c} is the carrier period .$$

FIG. 4 shows an embodiment according to the present invention arranged for calculating the determinant of a correlation matrix for two signals r₁(t) and r₂(t) in the RF domain which are denoted as: r_{RF1}(t) and r_{RF2}(t).

In the RF domain, the received information signals r_{RF1}(t) and r_{RF2}(t) are input to the selection means for the calculation of the determinant. σ₁₁ is calculated by first squaring r_{RF1}(t) using multiplier 60 followed by an integration using integrator 62. σ₂₂ is calculated by first squaring r₂(t) using multiplier 78 followed by an integration using integrator 80. The product σ₁₁σ₂₂ is calculated by multiplying σ₁₁ with σ₂₂ using multiplier 82. |σ₁₂|² is equal to Re(σ₁₂)²+Im (σ₂)². Re(σ₁₂)² is calculated by multiplying r_{RF1}(t) with r_{RF2}(t) using multiplier 64 followed by integration using integrator 66 and squaring of the signal using multiplier 68. Im (σ₁₂)² is calculated by first delaying r₂(t) 90 for a period t using delay 70 followed by a multiplication with r_{RF1}(t) using multiplier 72, integration using integrator 74 and squaring using multiplier 76. Finally |σ₁₂|² is obtained by adding Re(σ₁₂)² to Im (σ₁₂)² using adder 84. The determinant is calculated by subtracting |_{σ}₁₂|² from σ₁₁σ₂₂ by means of subtractor 86.

At base band level, the formulae for calculating σᵢᵢ and σᵢⱼ may take a different form. E.g. due to the fact that the information signals are being demodulated into in-phase and quadrature components. In this case the information signal rᵢ(t) in base band can be expressed as: r_{BBi}(t)=r_{Ii}(t)+j*r_{Qi}(t). Therefore, σᵢᵢ and σᵢⱼ can be calculated as:

$${σ}_{ii} = \frac{1}{T} {\int }_{T} {\vert {r}_{BBi} \vert}^{2} ( t ) ⅆ t , and {σ}_{ij} = \frac{1}{T} {\int }_{T} {r}_{BBi} ( t ) {r}_{BBj}^{*} ( t ) ⅆ t$$

FIG. 5 shows an other embodiment according to the present invention arranged for calculating the determinant of a correlation matrix for two signals r₁(t) and r₂(t) in the base band domain where r₁(t) and r₂(t) are denoted as r_{BB1}(t) and r_{BB2}(t)

σ₁₁ and σ₂₂ are calculated in the upper part of FIG. 10. σ₁₁ is calculated by first squaring r_{I1}(t) and r_{Q1}(t) using multipliers 68 and 110 followed by an integration of the squared signals using integrators 116 and 118. σ₁₁ is obtained by adding these integrated signals using adder 124. For calculating σ₂₂, the signals r_{I2}(t) and r_{Q2}(t) are squared using multipliers 112 and 114 followed by an integration using integrators 120 and 122. σ₂₂ is obtained by adding these integrated signals together using adder 126. σ₁₁σ₂₂ is obtained by multiplication of σ₁₁ with σ₂₂ using multiplier 128. Calculation of |σ₁₂|² is somewhat more complex as σ₁₂ comprises several cross products of the I and Q parts of r₁(t) and r₂(t). In total σ₁₂ comprises four cross products i.e. r_{I1}(t)*r_{I2}(t), r_{Q1}(t)*r_{Q2}(t), r_{I2}(t)*r_{Q1}(t) and r_{I1}(t)*r_{Q2}(t).
r_{I1}(t)*r_{I2}(t) is calculated by multiplying r_{I1}(t) with r_{I2}(t) using multiplier 138.
r_{Q1}(t)*r_{Q2}(t) is calculated by multiplying r_{Q1}(t) with r_{Q2}(t) using multiplier 140.
r_{I2}(t)*r_{Q1}(t) is calculated by multiplying r_{I2}(t) with r_{Q1}(t) using multiplier 142.
r_{I1}(t)*r_{Q2}(t) is calculated by multiplying r_{I1}(t) with r_{Q2}(t) using multiplier 146
   All cross products are subsequently integrated by integrators 148,150,154 and 156 respectively. The outcome of integrators 148 and 150 is added together using adder 152 followed by a squaring of the result using multiplier 160. The outcome of integrators 154 and 156 is subtracted from each other using sub tractor 158 followed by a subsequent squaring using multiplier 168. Finally |σ₁₂|² is obtained by adding the outcome of multipliers 160 and 162 together using adder 164. Subtracting |σ₁₂|² from σ₁₁σ₂₂ using sub tractor 166 yields the determinant of the correlation matrix.

In the digital domain σᵢᵢ and σᵢⱼ can be expressed as:

$${σ}_{ii} = \frac{1}{N} {\sum }_{n = 1}^{n = N} {\vert {r}_{Di} [ n ] \vert}^{2} , and {σ}_{ij} = \frac{1}{N} {\sum }_{n = 1}^{n = N} {r}_{Di} [ n ] {r}_{Dj}^{*} [ n ]$$

where r_{Di} [n] is the digitized information signal and N corresponds to the number of symbols. Calculation of the determinant in the digital domain is not shown here.

1. Apparatus comprising:
means for simultaneously receiving a first number of signals, a second number of possible signal pathways, said second number being larger than said first number,
means for determining a correlation between said first number of signals for each of said possible signal pathways,
means for selecting from said second number of possible signal pathways an optimal subset of signal pathways having a minimal correlation between said received first number of signals.

2. Apparatus according to claim 1 wherein said means for determining the correlation is arranged to determine the correlation using a determinant of a correlation matrix as a parameter.

3. Apparatus according to claim 1 wherein each of said second number of possible signal pathways comprises an antenna.

4. Apparatus according to claim 3 wherein each of said second number of possible signal pathways comprises processing means.

5. Apparatus according to claim 1 wherein said means for selecting the correlation is arranged to compare the correlation with a threshold value.

6. Apparatus according to claim 1 wherein the means for determining the correlation is further arranged to repeatedly determine the correlation and that said means for selecting said optimal subset from said second number of possible signal pathways is further arranged to repeatedly select said optimal subset.

7. Module for use in an apparatus that is arranged to simultaneously receive a first number of signals that can use a second number of possible signal pathways, said second number being larger than said first number, the module comprising:
means for determining a correlation between said first number of signals for each of said possible signal pathways,
means for selecting from said second number of possible signal pathways an optimal subset of signal pathways having a minimal correlation between said received first number of signals.

8. Computer program product for use in an apparatus that is arranged to simultaneously receive a first number of signals that can use a second number of possible signal pathways, said second number being larger than said first number, the computer program product being arranged to:
determine a correlation between the first number of signals for each of said signal pathways,
select from said second number of possible signal pathways an optimal subset of signal pathways having a minimal correlation between said received first number of signals.
